(19) United States
(12) Patent Application Publication
(10) Pub. No.: US 2025/0364936 A1
(43) Pub. Date: Nov. 27, 2025

(54) COOLING DISTRIBUTION DEVICE AND METHOD

(71) Applicant: LITE-ON TECHNOLOGY CORPORATION, Taipei (TW)

(72) Inventors: Lung-Fu WANG, Taipei (TW); Wen-Chi Chen, Taipei (TW); Ming-Wang Cheng, Taipei (TW); Yu-Kai Wang, Taipei (TW)

(21) Appl. No.: 19/293,473

(22) Filed: Aug. 7, 2025

Related U.S. Application Data
(60) Provisional application No. 63/694,937, filed on Sep. 16, 2024.

(30) Foreign Application Priority Data
May 16, 2025 (CN) 202510632285.9

(51) Int. Cl. H02P 27/06; H02J 9/06; H02M 5/458

(52) U.S. Cl. CPC H02P 27/06; H02J 9/062; H02M 5/458

(57) ABSTRACT

The application provides a cooling distribution device and method. The cooling distribution device includes: a backup battery module coupled to a power source; a variable frequency drive coupled to the power source and the backup battery module, the power source provides an input alternating current (AC) voltage, wherein when the input AC voltage is greater than a predetermined voltage value, the power source supplies power to the variable frequency drive, and when the input AC voltage is less than the predetermined voltage value, the backup battery module supplies power to the variable frequency drive; a controller coupled to the variable frequency drive; and a pump coupled to the variable frequency drive, the variable frequency drive providing an output AC voltage to the pump.

This application claims the benefit of U.S. provisional application Ser. No. 63/694,937, filed Sep. 16, 2024, and the People's Republic of China application serial no. 202510632285.9, filed on May 16, 2025, the disclosure of which is hereby incorporated by reference.

### TECHNICAL FIELD

The application relates to a cooling distribution device and method.

### BACKGROUND

The Cooling Distribution Unit (CDU) is a critical component in liquid cooling systems, used to evenly distribute coolant or water throughout the system. The CDU is responsible for regulating and controlling the flow rate of the coolant, maintaining optimal temperature and flow speed. The CDU typically operates in coordination with components such as pumps, radiators, heat exchangers, and controllers to ensure stable and efficient operation of the cooling system. Different types of CDUs are equipped with unique elements, such as sensors, monitors, and flow control valves. The CDU also helps keep the system clean by removing impurities from the coolant, preventing clogs, and avoiding damage to other components within the system. Overall, the CDU plays a crucial role in maintaining the proper operation of liquid cooling systems.

When a liquid cooling system is used, a CDU is required to ensure the system functions properly. The CDU helps regulate the flow of coolant within the cooling system, maintaining the ideal temperature and flow rate. By evenly distributing coolant throughout the system, the CDU provides necessary cooling for all system components, ensuring they operate within safe temperature ranges, preventing the system from exceeding its power design limits, and avoiding overheating and hardware damage.

In addition, the CDU works in coordination with other components of the cooling system to ensure efficient operation. By maintaining a stable coolant flow, the CDU reduces the burden on other system components, thereby improving overall system efficiency, delivering better performance, and extending the service life of the system.

Currently, most existing CDUs are powered by AC electricity from the mains supply. If the mains power fails, the CDU becomes non-operational. The industry seeks a technical solution that allows the CDU to continue functioning briefly during a power outage, thereby improving the safety and reliability of CDU applications.

Furthermore, in current liquid cooling systems, high-performance pumps are generally powered by alternating current (AC). However, in the current configurations of liquid cooling systems, power typically undergoes multiple AC/DC conversions, resulting in poor conversion efficiency. Therefore, the industry seeks a technical solution that can reduce the number of AC/DC conversions and improve the efficiency of power conversion.

### SUMMARY

One aspect of the application provides a cooling distribution device, comprising: a backup battery module coupled to a power source; a variable frequency drive coupled to the power source and the backup battery module, the power source provides an input alternating current (AC) voltage, wherein when the input AC voltage is greater than a predetermined voltage value, the power source supplies power to the variable frequency drive, and when the input AC voltage is less than the predetermined voltage value, the backup battery module supplies power to the variable frequency drive; a controller coupled to the variable frequency drive; and a pump coupled to the variable frequency drive, the variable frequency drive providing an output AC voltage to the pump.

Another aspect of the application provides a cooling distribution method, comprising: receiving an input alternating current (AC) voltage from a power source; in response to the input AC voltage being greater than a predetermined voltage value, supplying power from the power source to a variable frequency drive; in response to the input AC voltage being less than the predetermined voltage value, supplying power from a backup battery module to the variable frequency drive; and providing an output AC voltage from the variable frequency drive to a pump.

### BRIEF DESCRIPTION OF THE DRAWINGS

FIG. 1 illustrates a functional block diagram of a Cooling Distribution Unit (CDU) according to an embodiment of the present application.

FIG. 2 illustrates a detailed circuit diagram of the cooling distribution unit according to an embodiment of the present application.

FIG. 3 illustrates a waveform diagram of the switching signals of the cooling distribution unit shown in FIG. 2, according to an embodiment of the present application.

FIG. 4 illustrates a detailed circuit diagram of the backup battery module according to an embodiment of the present application.

FIG. 5 illustrates a detailed circuit diagram of the cooling distribution unit according to an embodiment of the present application.

FIG. 6 illustrates the waveform diagram of the switching signals of the cooling distribution device shown in FIG. 5 according to an embodiment of the present application.

FIG. 7 shows a flowchart of the cooling distribution method according to an embodiment of the present application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

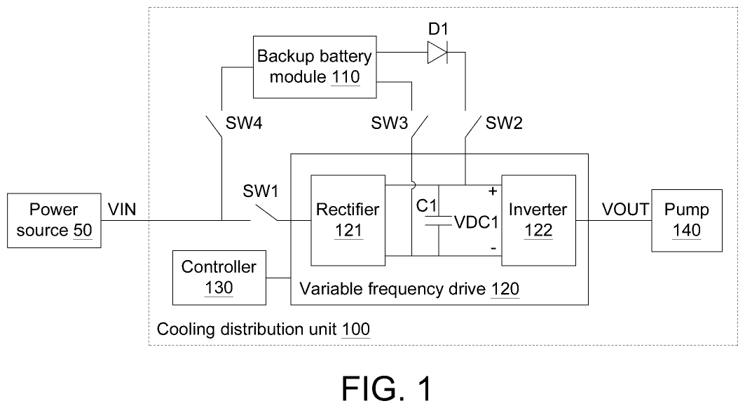

FIG. 1 illustrates a functional block diagram of a Cooling Distribution Unit (CDU) according to an embodiment of the present application. The cooling distribution unit 100 receives power from a power source 50. For example, but not limited to, the power source 50 may be a three-phase AC voltage ranging from 380V to 480V. The cooling distribution unit 100 includes: a backup battery module 110, a variable frequency drive (VFD) 120, a controller 130, a pump 140, a first switch SW1, a second switch SW2, a third switch SW3, a fourth switch SW4, and a first diode D1.

The backup battery module 110 is coupled to the power source 50. When the power source 50 is not experiencing a power outage (i.e., the power source 50 supplies power normally or when an input alternating current (AC) voltage VIN is greater than a predetermined voltage), the power source 50 charges the backup battery module 110. In the event of a power outage (i.e., the power source 50 is unable to supply power normally or when the input AC voltage VIN is less than the predetermined voltage), the backup battery module 110 supplies power to the VFD 120 so that the VFD 120 can continue operating normally.

The VFD 120 is coupled to the power source 50 through the first switch SW1. The VFD 120 is also coupled to the backup battery module 110 through the second switch SW2, the third switch SW3, and the first diode D1. When the power source 50 is operating normally (i.e. when the input AC voltage VIN is greater than the predetermined voltage), the power source 50 provides an input AC voltage VIN to the VFD 120 to enable normal operation of the VFD 120. When the power source 50 is down (i.e. when the input AC voltage VIN is less than the predetermined voltage), the backup battery module 110 supplies power to the VFD 120 so that the VFD 120 can continue operating normally.

The VFD 120 includes a rectifier 121, an inverter 122, and a capacitor C1. The rectifier 121 is coupled to the power source 50 via the first switch SW1. The rectifier 121 converts the input AC voltage VIN from the power source 50 into a first DC voltage VDC1. The inverter 122 is coupled to the rectifier 121 and converts the first DC voltage VDC1 into an output AC voltage VOUT, which is supplied to downstream components (such as the pump 140).

The capacitor C1 of the VFD 120 is coupled between the rectifier 121 and the inverter 122 and is used to filter the first DC voltage VDC1 provided by the rectifier 121 to the inverter 122.

The controller 130 is coupled to the VFD 120 and is used to configure/control the operating frequency and other parameters of the VFD 120. Operational details of the controller 130 will be described below.

The pump 140 is coupled to the VFD 120 and receives the output AC voltage VOUT provided by the VFD 120 to drive the circulation of coolant within the system. The pump 140 may be a three-phase pump.

The first switch SW1 is coupled between the power source 50 and the VFD 120. The first switch SW1 is controlled by the controller 130.

The second switch SW2 is coupled between the first diode D1 and the VFD 120. The second switch SW2 is controlled by the controller 130.

The third switch SW3 is coupled between the backup battery module 110 and the VFD 120. The third switch SW3 is controlled by the controller 130. The controller 130 is coupled to the first switch SW1, second switch SW2, and third switch SW3. When the power source 50 is operating normally (i.e. when the input AC voltage VIN is greater than the predetermined voltage), the controller 130 controls the first switch SW1 to be on, and the second switch SW2 and third switch SW3 to be off. When the power source 50 fails (i.e. when the input AC voltage VIN is less than the predetermined voltage), the controller 130 turns off the first switch SW1 and turns on the second switch SW2 and third switch SW3.

The fourth switch SW4 is coupled between the power source 50 and the backup battery module 110. The fourth switch SW4 is controlled by the controller 130.

The first diode D1 is coupled between the backup battery module 110 and the second switch SW2.

The operating principles of the cooling distribution unit 100 in one embodiment will now be described.

When the power source 50 is not experiencing a power outage (i.e., the power source 50 supplies power normally) (i.e. when the input AC voltage VIN is greater than the predetermined voltage), the power source 50 provides an input AC voltage VIN to charge the backup battery module 110 (with the fourth switch SW4 turned on), and also supplies power to the VFD 120 (with the first switch SW1 turned on), allowing the VFD 120 to operate normally and generate an output AC voltage VOUT to the pump 140 so that the pump 140 can function properly.

In the event of a power outage (i.e., the power source 50 fails to supply power normally) (i.e. when the input AC voltage VIN is less than the predetermined voltage), the fourth switch SW4 is turned off, preventing the power source 50 from providing the input AC voltage VIN to the backup battery module 110. At this time, the backup battery module 110 supplies power to the VFD 120 to enable the VFD 120 to continue operating normally, and the VFD 120 generates the output AC voltage VOUT to the pump 140 so that the pump 140 can continue operating.

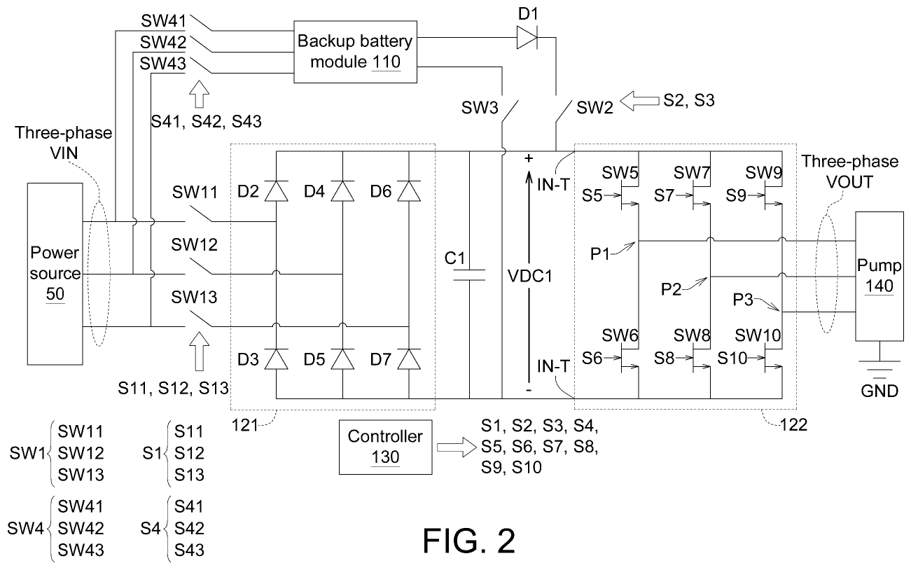

FIG. 2 illustrates a detailed circuit diagram of the cooling distribution unit according to an embodiment of the present application. As shown in FIG. 2, the rectifier 121 includes diodes D2-D7. The inverter 122 includes: a fifth switch SW5, a sixth switch SW6, a seventh switch SW7, an eighth switch SW8, a ninth switch SW9, a tenth switch SW10, and two input terminals IN-T.

The sixth switch SW6 is coupled to the fifth switch SW5 and the first output terminal P1. The eighth switch SW8 is coupled to the seventh switch SW7 and the second output terminal P2. The tenth switch SW10 is coupled to the ninth switch SW9 and the third output terminal P3.

The two input terminals IN-T are coupled to the rectifier 121 to receive the first DC voltage VDC1. The fifth switch SW5, seventh switch SW7, and ninth switch SW9 are coupled to one of the input terminals IN-T, while the sixth switch SW6, eighth switch SW8, and tenth switch SW10 are coupled to the other input terminal IN-T.

The controller 130 outputs multiple switching signals S1-S10 to the switches SW1-SW10 to control their on/off states.

The output AC voltage VOUT is a three-phase output AC voltage. The inverter 122 provides the three-phase output AC voltage VOUT to the pump 140 via the first output terminal P1, second output terminal P2, and third output terminal P3.

The diode D2 is coupled to the switch SW11. The diode D3 is coupled to both the switch SW11 and the diode D2. The diode D4 is coupled to the switch SW12. The diode D5 is coupled to both the switch SW12 and the diode D4. The diode D6 is coupled to the switch SW13. The diode D7 is coupled to both the switch SW13 and the diode D6.

The first switch SW1 in FIG. 1 is equivalent to switches SW11-SW13 in FIG. 2. When the power source 50 is not in a power outage, the controller 130 controls switches SW11-SW13 to turn on. When the power source 50 is in a power outage, the controller 130 controls switches SW11-SW13 to turn off. Similarly, the controller 130 outputs multiple switching signals S1-S3 to the first switch SW1, second switch SW2, and third switch SW3. The switching signals S11-S13 are equivalent to switching signal S1. Likewise, the fourth switch SW4 in FIG. 1 is equivalent to switches SW41-SW43 in FIG. 2. The controller 130 outputs switching signal S4 to the fourth switch SW4 and outputs multiple switching signals S41-S43 to these switches SW41-SW43.

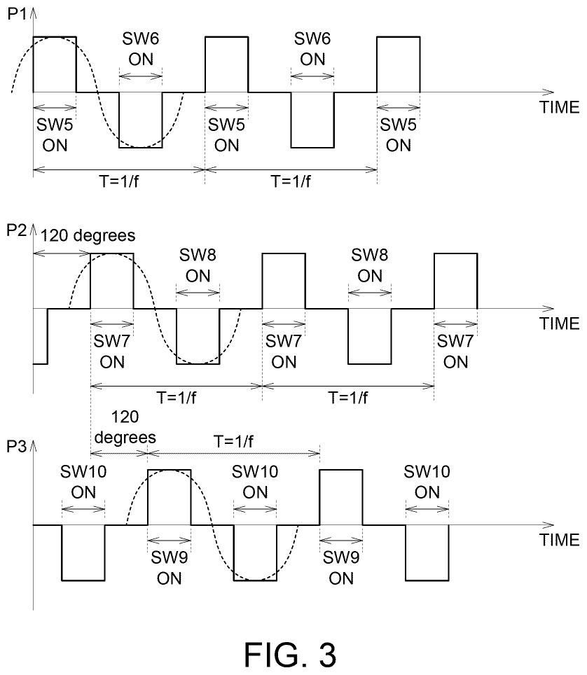

FIG. 3 illustrates a waveform diagram of the switching signals of the cooling distribution unit shown in FIG. 2, according to an embodiment of the present application. The controller 130 adjusts the switching frequency f of the aforementioned switching signals S5-S10, where f=(1/T), and T represents the period.

As shown in FIG. 3, during the first half-cycle, the switch SW5 is turned on (i.e., when the switching signal S5 has a high voltage level), and the inverter 122 provides the three-phase output AC voltage VOUT to the pump 140 through the first output terminal P1. In some time intervals, SW5 and SW6 may both be turned off simultaneously. During the second half-cycle, the switch SW6 is turned on (i.e., when the switching signal S6 has a high voltage level), and the inverter 122 again provides the output AC voltage VOUT to the pump 140 through the first output terminal P1. The remaining operations follow a similar pattern. Since the switching signals are spaced 120 degrees apart in phase, the output AC voltage VOUT provided by the first output terminal P1, second output terminal P2, and third output terminal P3 is a three-phase output AC voltage VOUT.

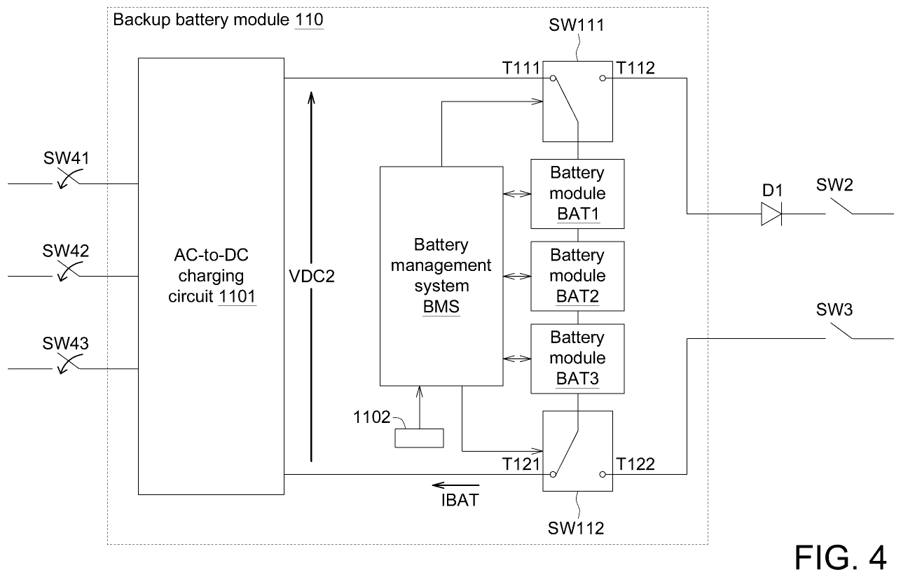

FIG. 4 illustrates a detailed circuit diagram of the backup battery module according to an embodiment of the present application. As shown in FIG. 4, the backup battery module 110 includes: an AC-to-DC charging circuit 1101 coupled to the fourth switches SW41-SW43 and outputs a second DC voltage VDC2; a plurality of battery modules (e.g., BAT1-BAT3, though not limited thereto), which are connected in series; an eleventh switch SW111 coupled to the first diode D1; and a twelfth switch SW112 coupled to the third switch SW3. Both the eleventh switch SW111 and the twelfth switch SW112 are coupled to the AC-to-DC charging circuit 1101 to receive the second DC voltage VDC2 and are also coupled to the battery modules BAT1-BAT3.

When the power source 50 is not experiencing a power outage (i.e. when the input AC voltage VIN is greater than the predetermined voltage), the eleventh switch SW111 and the twelfth switch SW112 are configured to couple the AC-to-DC charging circuit 1101 to the battery modules BAT1-BAT3.

When the power source 50 is experiencing a power outage (i.e. when the input AC voltage VIN is less than the predetermined voltage), the eleventh switch SW111 and the twelfth switch SW112 are configured to couple the battery modules BAT1-BAT3 to the first diode D1 and the third switch SW3.

The eleventh switch SW111 and the twelfth switch SW112 are three-way switches.

The backup battery module 110 further includes a battery management system (BMS) and a current sensor 1102. One terminal of the eleventh switch SW111 is coupled to the battery module BAT1. The other two terminals T111 and T112 of the eleventh switch SW111 are coupled to the AC-to-DC charging circuit 1101 and the first diode D1, respectively.

One terminal of the twelfth switch SW112 is coupled to the battery module BAT3. The other two terminals T121 and T122 of the twelfth switch SW112 are coupled to the AC-to-DC charging circuit 1101 and the third switch SW3, respectively.

The current sensor 1102 is coupled to the battery management system BMS and the twelfth switch SW112 to sense the battery current IBAT flowing through battery modules BAT1, BAT2, and BAT3, and to transmit the sensed current to the battery management system BMS.

The battery management system BMS is coupled to the battery modules BAT1, BAT2, BAT3, as well as the eleventh switch SW111 and the twelfth switch SW112. The BMS manages the battery modules BAT1, BAT2, and BAT3 based on the sensed current and controls switching of the eleventh switch SW111 and the twelfth switch SW112.

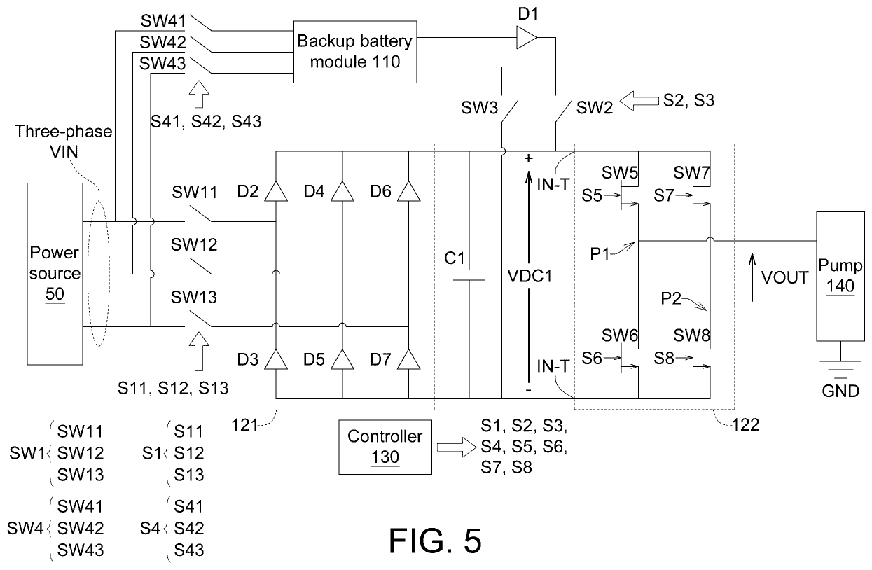

FIG. 5 illustrates a detailed circuit diagram of the cooling distribution unit according to an embodiment of the present application. As shown in FIG. 5, the inverter 122 includes: a fifth switch SW5, a sixth switch SW6, a seventh switch SW7, an eighth switch SW8, and two input terminals IN-T.

The sixth switch SW6 is coupled to the fifth switch SW5 and the first output terminal P1. The eighth switch SW8 is coupled to the seventh switch SW7 and the second output terminal P2.

The two input terminals IN-T are coupled to the rectifier 121 to receive the first DC voltage VDC1. The fifth switch SW5 and the seventh switch SW7 are coupled to one of the input terminals IN-T, and the sixth switch SW6 and the eighth switch SW8 are coupled to the other input terminal IN-T.

The controller 130 outputs a plurality of switching signals S5-S8 to the fifth switch SW5, sixth switch SW6, seventh switch SW7, and eighth switch SW8 to control the switching (i.e., on/off states) of these switches SW5-SW8.

The output AC voltage VOUT is a single-phase output AC voltage. The inverter 122 provides the single-phase output AC voltage VOUT to the pump 140 through the first output terminal P1 and the second output terminal P2.

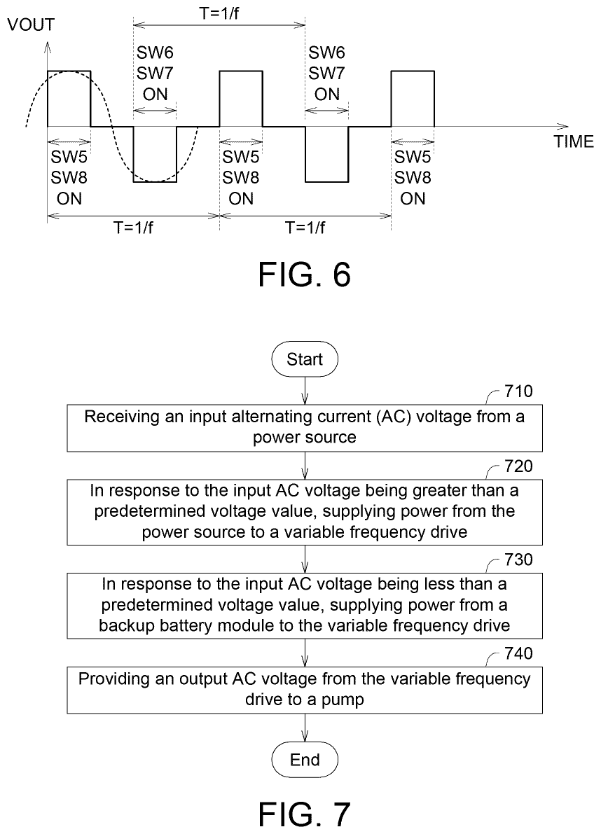

FIG. 6 illustrates the waveform diagram of the switching signals of the cooling distribution device shown in FIG. 5 according to an embodiment of the present application.

The controller 130 adjusts the switching frequency f of the plurality of switching signals S5-S8, where f=1/T, and T represents the period.

As shown in FIG. 6, during the first half-cycle, the fifth switch SW5 and the eighth switch SW8 are turned on (i.e., when switching signals S5 and S8 have a high voltage level), and the inverter 122 provides a single-phase output AC voltage VOUT to the pump 140 through the first output terminal P1 and the second output terminal P2. During certain periods, all four switches-SW5, SW6, SW7, and SW8—can be turned off simultaneously. During the second half-cycle, the sixth switch SW6 and the seventh switch SW7 are turned on, and the inverter 122 again provides the single-phase output AC voltage VOUT to the pump 140 through the first output terminal P1 and the second output terminal P2. The rest of the operation follows a similar pattern.

FIG. 7 shows a flowchart of the cooling distribution method according to an embodiment of the present application. The cooling distribution method includes the following steps: (710) receiving an input alternating current (AC) voltage from a power source; (720) in response to the input AC voltage being greater than a predetermined voltage value, supplying power from the power source to a variable frequency drive; (730) in response to the input AC voltage being less than a predetermined voltage value, supplying power from a backup battery module to the variable frequency drive; and (740) providing an output AC voltage from the variable frequency drive to a pump. Furthermore, depending on whether the power source is in an outage state (i.e. whether the input AC voltage VIN is greater than the predetermined voltage), the backup battery module is either charged by the power source or supplies power to the inverter.

From the above, it is understood that in one embodiment of the present application, the CDU (Cooling Distribution Unit) has a battery backup module. Even when utility power is lost, the CDU can continue to operate for a short time, thereby enhancing the operational safety of the CDU.

From the above, it is also evident that the embodiment of the present application requires fewer AC/DC conversions. Unlike conventional methods that involve multiple AC/DC conversions, this embodiment improves overall conversion efficiency by reducing such conversions.

The foregoing primarily describes the solution provided in the present embodiment from the perspective of the cooling distribution device. It should be understood that, to realize the above functions, the cooling distribution device includes corresponding hardware structures and/or software modules that execute the functions. Those skilled in the art will readily appreciate that, in combination with the units and algorithm steps described in the embodiments herein, the present application may be implemented in hardware form or as a combination of hardware and software, depending on the specific application and design constraints of the technical solution. Skilled persons may employ various methods to implement the functions described for each particular application, but such implementations should not be regarded as beyond the scope of the present application.

In one embodiment of the present application, the cooling distribution device may be divided into functional modules based on the aforementioned method example. For instance, the division may be based on each corresponding function to obtain individual function modules, or two or more functions may be integrated into one processing module. The integrated module may be implemented in hardware form or as a software functional module. It is noted that the division into modules in the present embodiment is merely exemplary and represents a logical functional partition. In practical implementations, other partitioning schemes may be used. The following description uses an example based on dividing according to each corresponding function to obtain each function module.

Although many specific details may be described herein, these should not be understood as limiting the scope of the application, but rather as descriptions of particular embodiments. In the specification, certain features described in the context of a single embodiment may also be implemented in combination within a single embodiment. Conversely, various features described in the context of a single embodiment may be implemented individually or in any suitable sub-combination across multiple embodiments. Moreover, although features may initially be described as functioning in certain combinations or may be initially described as such combinations, in some cases one or more features may be removed from the combination, and the described combination may be directed to a sub-combination or variation thereof. Similarly, although operations are depicted in figures as occurring in a particular order, this should not be understood as requiring that the operations must be performed in the shown specific order or sequence, nor that all depicted operations must be performed to achieve the desired result.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A cooling distribution device, comprising:
a backup battery module coupled to a power source;
a variable frequency drive coupled to the power source and the backup battery module, the power source provides an input alternating current (AC) voltage, wherein when the input AC voltage is greater than a predetermined voltage value, the power source supplies power to the variable frequency drive, and when the input AC voltage is less than the predetermined voltage value, the backup battery module supplies power to the variable frequency drive;
a controller coupled to the variable frequency drive; and
a pump coupled to the variable frequency drive, the variable frequency drive providing an output AC voltage to the pump.

2. The cooling distribution device according to claim 1, wherein the variable frequency drive comprises:
a rectifier coupled to the power source, the rectifier rectifying the input AC voltage into a first DC voltage;
an inverter coupled to the rectifier to receive the first DC voltage, converting the first DC voltage into the output AC voltage and providing the output AC voltage to the pump; and
a capacitor coupled between the rectifier and the inverter.

3. The cooling distribution device according to claim 2, further comprising:
a first switch coupled between the power source and the rectifier;
a second switch coupled to the inverter;
a third switch coupled between the backup battery module and the inverter; and
a first diode coupled between the backup battery module and the second switch.

4. The cooling distribution device according to claim 3, wherein:
the controller is coupled to the first switch, the second switch, and the third switch;
when the input AC voltage is greater than the predetermined voltage value, the first switch is turned on, and the second switch and the third switch are turned off; and
when the input AC voltage is less than the predetermined voltage value, the first switch is turned off, and the second switch and the third switch are turned on.

5. The cooling distribution device according to claim 4, further comprising a fourth switch coupled between the power source and the backup battery module, the controller being coupled to the fourth switch, wherein:
when the input AC voltage is greater than the predetermined voltage value, the fourth switch is turned on; and
when the input AC voltage is less than the predetermined voltage value, the fourth switch is turned off.

6. The cooling distribution device according to claim 5, wherein the inverter comprises:
a fifth switch;
a sixth switch coupled to the fifth switch and a first output terminal;
a seventh switch;
an eighth switch coupled to the seventh switch and a second output terminal;
a ninth switch;
a tenth switch coupled to the ninth switch and a third output terminal; and
two input terminals coupled to the rectifier to receive the first DC voltage;
wherein the fifth switch, the seventh switch, and the ninth switch are coupled to one of the two input terminals,
the sixth switch, the eighth switch, and the tenth switch are coupled to the other of the two input terminals,
the controller outputs a plurality of switching signals to the fifth switch, the sixth switch, the seventh switch, the eighth switch, the ninth switch, and the tenth switch,
the output AC voltage is a three-phase output AC voltage, and
the inverter provides the three-phase output AC voltage to the pump via the first output terminal, the second output terminal, and the third output terminal.

7. The cooling distribution device according to claim 5, wherein the inverter comprises:
a fifth switch;
a sixth switch coupled to the fifth switch and a first output terminal;
a seventh switch;
an eighth switch coupled to the seventh switch and a second output terminal; and
two input terminals coupled to the rectifier to receive the first DC voltage;
wherein the fifth switch and the seventh switch are coupled to one of the input terminals,
the sixth switch and the eighth switch are coupled to the other input terminal,
the controller outputs a plurality of switching signals to the fifth switch, the sixth switch, the seventh switch, and the eighth switch, and
the inverter provides the output AC voltage to the pump via the first output terminal and the second output terminal.

8. The cooling distribution device according to claim 6, wherein the controller adjusts a switching frequency of the switching signals.

9. The cooling distribution device according to claim 7, wherein the controller adjusts a switching frequency of the switching signals.

10. The cooling distribution device according to claim 5, wherein the backup battery module comprises:
an AC-to-DC charging circuit coupled to the fourth switch and outputting a second DC voltage;
a plurality of battery modules connected in series;
an eleventh switch coupled to the first diode; and
a twelfth switch coupled to the third switch;
wherein the eleventh switch and the twelfth switch are coupled to the AC-to-DC charging circuit to receive the second DC voltage and are coupled to the battery modules;
when the input AC voltage is greater than the predetermined voltage value, the eleventh switch and the twelfth switch are configured to couple the AC-to-DC charging circuit to the battery modules;
when the input AC voltage is less than the predetermined voltage value, the eleventh switch and the twelfth switch are configured to couple the battery modules to the first diode and the third switch.

11. The cooling distribution device according to claim 10, wherein the eleventh switch and the twelfth switch are three-way switches.

12. A cooling distribution method, comprising:
receiving an input alternating current (AC) voltage from a power source;
in response to the input AC voltage being greater than a predetermined voltage value, supplying power from the power source to a variable frequency drive;
in response to the input AC voltage being less than the predetermined voltage value, supplying power from a backup battery module to the variable frequency drive; and
providing an output AC voltage from the variable frequency drive to a pump.

13. The cooling distribution method according to claim 12, wherein the step of providing the output AC voltage to the pump from the variable frequency drive comprises:
rectifying the input AC voltage into a first DC voltage by a rectifier; and
converting the first DC voltage into the output AC voltage by an inverter to provide the output AC voltage to the pump.

14. The cooling distribution method according to claim 13, wherein:
in response to the input AC voltage being greater than the predetermined voltage value, controlling a first switch coupled between the power source and the rectifier to be turned on, controlling a second switch coupled to the inverter to be turned off, wherein a first diode is coupled between the backup battery module and the second switch, and controlling a third switch coupled between the backup battery module and the inverter to be turned off; and
in response to the input AC voltage being less than the predetermined voltage value, controlling the first switch to be turned off, and controlling the second switch and the third switch to be turned on.

15. The cooling distribution method according to claim 12, wherein in response to the input AC voltage being greater than the predetermined voltage value, the power source charges the backup battery module.
